(19) United States
(12) Patent Application Publication
(10) Pub. No.: US 2005/0004986 A1
(43) Pub. Date: Jan. 6, 2005

(54) Remote population of computer clipboard via a messaging system

(76) Inventors: Norihiro Edwin Aoki, Sunnyvale, CA (US); Brock Daniel Laporte, San Carlos, CA (US)

Correspondence Address: GLENN PATENT GROUP, 3475 EDISON WAY, SUITE L, MENLO PARK, CA, 94025, US

(21) Appl. No.: 10/613,435

(22) Filed: Jul. 3, 2003

(51) Int. Cl. G06F 15/16

(52) U.S. Cl. 709/206

(57) ABSTRACT

The invention provides a system and method for transferring a fragment of a document via an Internet based messaging system, with the transferred data being available on a receiving computer's clipboard, when pasted into another document in the receiving computer, the transferred data restoring as a fragment in the same format as the original document.

### BACKGROUND OF THE INVENTION

1. Field of the Invention

This invention generally relates to Internet based data transfer technology. More particularly, the invention relates to a system and method for transferring a fragment of a document via an Internet based messaging system, with the transferred data being available on a receiving computer's clipboard, when pasted into another document in the receiving computer, the transferred data restoring the same format as the original document.

2. Description of the Prior Art

Clipboard

As a component of a computer's operating system, a clipboard provides a temporary memory area for transferring information within a document being edited, between documents or between programs. Basic clipboard operations are “Cut”, “Copy” and “Paste.” “Cut” deletes the selected part of a document and moves the data to the clipboard. “Copy” copies the data to the clipboard and leaves the document unchanged. “Paste” inserts the clipboard contents into the original document or another document in place of any currently selected data.

Different graphical user interfaces (GUI) vary in how they handle the different types of data which a user might want to transfer via the clipboard. Some systems support only plain text. Some others support arbitrarily typed data. More sophisticated operating systems support copy and paste of different data types between different applications, possibly with automatic format conversion, for example, from rich text to plain ASCII.

Synchronizing Clipboards of Multiple Computers

As computing devices proliferate and more users own and use multiple computers, such as desktop computers, laptops, and personal digital assistants (PDAs), the problem of transferring data among one's own computers becomes increasingly important. It is desirable to extend the copy-and-paste tool, already familiar to users for data transfer between applications, so that data can be easily transferred between computers via clipboards. R. Miller and B. Myers, Synchronizing Clipboards of Multiple Computers, (http://www-2.cs.cmu.edu/˜rcm/papers/uist99/uist99.html) describe a new technique, called synchronized clipboard, for seamlessly transferring data between computers.

According to Miller, et al, multiple computers can share a synchronized clipboard for all clipboard operations so that data copied to the clipboard from one computer, using the standard “Copy” command, can be pasted directly on another computer using the standard “Paste” command. A synchronized clipboard ensures that the clipboards of two or more connected computers are always identical.

In the Miller, et al model, each user has a personal clipboard group consisting of the computers on their desks and in their pockets, which all share a synchronized clipboard. The clipboard group is currently configured manually, but personal wireless networks may eventually allow automatic group configuration based on physical proximity. Other computers may temporarily join the clipboard group, for instance if visitors want to carry away data on their portable computers. However, two users should not share a synchronized clipboard for long because their clipboard operations would interfere. In addition, clipboard contents are in hidden state, thus copied data must be pasted before the user forgets about it. A synchronized clipboard makes sense for a single user transferring data between computers on the same desk, but not between a computer at work and another at home.

Some network clipboard programs, such as the ClipBook Viewer included in Microsoft Windows, allow a computer's clipboard to be shared across a network, but do not provide automatic synchronization. As a result, at some point during a copy-and-paste operation, those clipboard programs must ask the user for the name of the other computer. The Miller, et al synchronized clipboard omits this step. Once configured, the synchronized clipboard is invisible to the user.

Miller, et al have also developed a system, called Remote Clip, for synchronizing clipboards across a network. Written in Java, Remote Clip uses Java's Remote Method Invocation (RMI) to communicate with its peers across the network. In their system, a clipboard group is configured manually by running Remote Clip on every machine in the group and specifying the hostnames of the other group members in a setup dialog.

The Remote Clip system is peer-to-peer. The synchronized clipboard is owned by the computer where the most recent copy operation occurred. When a copy operation occurs on computer X, for example, X notifies the other members of its clipboard group that it is taking ownership of the synchronized clipboard. If a paste operation subsequently occurs on computer Y, then Y satisfies the paste by retrieving the clipboard contents from X. Note that no clipboard data is transferred until a remote paste actually occurs, so the clipboard owner can change the clipboard contents repeatedly without notifying other group members. Thus, a sequence of local copies and pastes proceeds at full speed without any network traffic.

In addition to text, Remote Clip can transfer files and directories, packing them into a ZIP archive that is unpacked automatically by a receiver. On Microsoft Windows, Remote Clip uses native code to copy and paste files directly into the Windows file browser. On other platforms, users can copy and paste files using either a GUI or command-line programs.

The Remote Click requires setup prior to being usable. In addition, it does not work within a messaging system.

Microsoft's Messaging API

A messaging system includes a messaging application programming interface (MAPI) which refers to a messaging architecture and a client interface component for applications such as e-mail, scheduling, calendaring, and document management. As a messaging architecture, MAPI provides a consistent interface for multiple application programs to interact with multiple messaging systems across a variety of hardware platforms.

MAPI has a comprehensive, open, dual-purpose interface, integrated with Microsoft Windows and can be used by all levels and types of client application and service providers driver-like components that provide a MAPI interface to a specific messaging system. For example, a word processor can send documents and a workgroup application can share and store different types of data using MAPI.

MAPI separates the programming interfaces used by the client applications and the service providers. Every component works with a common, Microsoft Windows-based user interface. For example, a single messaging client application can be used to receive messages from fax, a bulletin board system, a host-based messaging system and a LAN-based system. Messages from all of these systems can be delivered to a single universal inbox.

MAPI is aimed at workgroup applications that communicate with different messaging systems. Because workgroup applications demand more of their messaging systems, MAPI offers much more than basic messaging in the programming interface and supports more than LAN-based messaging systems. Applications can, for example, format text for a single message with a variety of fonts and present to their users a customized view of messages that have been filtered, sorted or preprocessed.

MAPI is built into Windows. The programming interface and subsystem contained in the MAPI data layer link (DLL) provide objects which conform to the Component Object Model (COM). MAPI includes standard messaging client applications that demonstrate different levels of messaging support.

NetMeeting

NetMeeting is a messaging system developed by Microsoft which enables users to communicate in numerous ways such as chatting, telephoning, sharing a whiteboard for drawing, and sharing a program. The sharing program feature allows meeting participants to view and work on files simultaneously. For example, a user may have a Microsoft Excel document that several people need to work on. The user can open the document on her computer, share it, and then everyone can provide their comments directly in the document. Only the person who has opened the file is required to have the program on their computer. Other participants can work on the document without having the program. Only one person can be in control of a shared program at a time. If “controllable” appears in the title bar of the shared program window, the person who shared the program has control and allows others to work in the program. If the mouse pointer has a box with initials, then another meeting participant has control of the program. Note that all meeting participants can share programs during a meeting. The shared programs of each participant appear in separate shared program windows on the other participants' desktops.

To share a program, the user clicks the “Share Program” button, and then, in the “Sharing” dialog box, clicks the name of the program that the user wants to share. Finally, the user clicks “Share.” If the users share a Windows Explorer window, such as My Computer, Control Panel, or a folder on his computer, he is sharing all Explorer windows he has open. Also, once he has shared such a window, every program he starts while he is still in the meeting is shared with the other participants automatically.

To allow control of a shared program, the user just clicks “Allow Control” button in the “Sharing” dialog box; then in the main NetMeeting window, right-clicks the name of a person he wants to work in the program, and then clicks “Grant Control.”

To work in a program shared by someone else, the user clicks “Request Control” on the “Control” menu of the shared program window. Only participants who have NetMeeting installed can work in a shared program. The person who shared the program must click “Allow Control” in the “Sharing” dialog box before he can click “Request Control”. When the user clicks “Request Control”, the person who shared the program receives a confirmation message and must click “Accept” before the user can work in the shared program. If a document is created during collaboration, only the person who shared the program can distribute the file.

NetMeeting is well suited for the situation where people want the exact version of a document and only one person can be editing at a time. In some different situations, however, people may not want to have an exact version of a document but just a fragment of that document ready to be pasted into another document.

In fact, although all existing messaging systems, such as MSN, Yahoo Messerger, AIM, and NetMeeting, allow users to exchange textual data directly through the communication screen and allow users to send a document or a photo to a receiving user's e-mail address, they do not facilitate transfer of entire data from a sending user's clipboard to a receiving user's clipboard, and thus a sending user cannot use any of the current messaging systems to send a fragment of document to a receiving user's clipboard so that the receiving user pastes the clipboard content into a document in the receiving computer.

What is desired is a mechanism that allows copying a fragment of a document from a sending computer and populating a remote receiving computer's clipboard via an Internet based messaging system, so that the receiving user at the remote receiving computer can paste the transferred fragment into another document using a standard paste command.

### SUMMARY OF THE INVENTION

This invention provides a system and method for transferring a fragment of a document via an Internet based messaging system, with the transferred data being immediately available on a receiving computer's clipboard, when pasted into another document in the receiving computer, the transferred data restoring as in the same format as the original document. Meta-data accompanies the message so that the data can be identified. Any type of computer program that supports “cut, copy and paste” would benefit from the ability to exchange file fragments easily.

In the preferred embodiment of the invention, a receiving user may have the receiving computer's clipboard populated by a single click on the messaging system's user interface, and thus the entire data that has been transferred via the messaging system's client application, including the document data and the meta-data for maintaining the document format, is ready to be pasted in a place selected by the receiving user. In one implementation of the invention, the messaging system displays an automatically generated system message in the communication screen where messages are displayed. The system message includes a link which is notable, for example, as highlighted or underlined. When the receiving user clicks the link, the entire data transferred from the sending computer is then exported to the receiving computer's clipboard. In the sending user's side, when the messaging system's entry box is clicked and then a standard paste command is given, the entire data in the sending computer's clipboard is imported into the messaging system's client application in the sending computer. When the sending user gives a transfer command, such as a click on a “Send” button, the above mentioned system message including the notable link is automatically displayed in the communication screen.

There are different implementations as for when the entire data is actually transferred from the sending computer's clipboard to the messaging system's client application in the sending computer, from the sending computer to the receiving computer via the messaging system, and from the messaging system's client application in the receiving computer to the receiving computer's clipboard. In one of these implementations, when the sending user applies a paste command, the entire data in the sending computer's clipboard is imported into the messaging system's client application in the sending computer. When the sending user clicks “Send,” the entire data is actually transferred from the sending computer to the receiving computer. When the receiving user clicks the link in the system message, the entire data is further transferred from the messaging system's client application in the receiving computer to the receiving computer's clipboard.

In another implementation, when the sending user applies a paste command, the messaging system display a first system message in the message entry box but the entire data in the sending computer's clipboard is not transferred into the messaging system. When the sending user clicks the “Send” button, the entire data in the sending computer's clipboard starts being transferred to the messaging system's client application in the sending computer and then to the messaging system's client application in the receiving computer. At the same time, a second system message is automatically displayed in the communication screen. When the receiving user clicks the link in the second system message, the entire data is further transferred from the messaging system's client application in the receiving computer to the receiving computer's clipboard.

Yet in another implementation, when the sending user applies a paste command, the messaging system display a first system message in the message entry box but the entire data in the sending computer's clipboard is not transferred into the messaging system. When the sending user clicks the “Send” button, only a second system message is displayed in the communication screen but the entire data in the sending computer's clipboard is not transferred. When the receiving user clicks the link in the second system message, the entire data is transferred from the sending computer's clipboard to the receiving computer's clipboard via the messaging system's client applications in the sending and receiving computers.

### BRIEF DESCRIPTION OF THE DRAWINGS

FIG. 1 is a schematic diagram illustrating an instant messaging system via which a sending user sends a fragment of document to a receiving user and the receiving user then pastes the fragment from the receiving computer's clipboard into a document;

FIG. 2A is a flow diagram illustrating an exemplary process for transferring a fragment of document from a sending computer's clipboard to a receiving computer's clipboard via an instant messaging system;

FIG. 2B is a schematic diagram illustrating an exemplary system message in the message entry box invoked by the sending user's “Paste” command;

FIG. 3A is a schematic block diagram illustrating an implementation where data transfer occurs when each of the commands “Paste,” “Send,” and “Link Click” is given;

FIG. 3B is a schematic block diagram illustrating an implementation where data transfer occurs when the “Send” command is given and then when the “Link Click” command is given; and

FIG. 3C is a schematic block diagram illustrating an implementation where data transfer occurs when the “Link Click” command is finally given.

### DETAILED DESCRIPTION OF THE INVENTION

This invention facilitates collaboration between individuals or groups of people who are collectively modifying computer documents. A sending user can take the contents of any clipboard on any major computer operating system and sends that data to a receiving user at a receiving computer, who could then choose to populate the receiving computer's clipboard with that data. The receiving user can then paste the data into a selected place, most likely guided by contextual data accompanying the main message.

The invention uses standard OS clipboard Copy/Paste functionality to put copied data into a specific messaging client application, such as AOL's instant messenger (AIM). Users' other application programs implement their own clipboard format, and the formatted data can be accessed by the messaging system's client application. Clipboard contents, i.e. the entire formatted data are then sent to the messaging system's client application in the receiving computer, where the receiving user receives an interface link akin to “This message contains data from <Microsoft Excel> formatted for your clipboard. Click here to place this data into your clipboard.”

When a sending user selects and copies a fragment of document, the meta-data required to maintain the document format is already available and discoverable in the sending computer's clipboard. An application program, such as Excel, places data on the clipboard in multiple formats—corresponding to differing abilities to reproduce the information faithfully. Thus, Excel might put two versions of the data on the clipboard—one is a full spreadsheet view and the other is just the rows and columns in textual format. In the existing messaging systems, the client application asks for only the version of the data it can understand—in this case, the textual representation. However, in the present invention, the messaging client application can retrieve the entirety of the clipboard—essentially asking the operating system to retrieve all versions of the data, whether the messaging client application could understand it or not. It then transits the data across the instant messaging communications channel, and then deposits all of the formats on the receiving computer's clipboard. It is then up to the receiving computer's application to determine which of the multiple formats it is able to consume.

The clipboard contents of the receiving computer can be pasted, via a normal OS Paste command, into another document that understands the formatted data. Note that, unlike various messaging systems that transfer files using attachments, this solution does not have to create a separate document containing the fragment and then send the document. Rather, the copied fragment is sent directly via the messaging system. Also note that the receiving user has to manually select a place in an appropriate document where the transferred fragment could be pasted. The “paste” step should not be automated in most circumstances because, for example, an ordinary user does not want the computer automatically paste a fragment of Word or Excel document into an existing document without the user's express authorization.

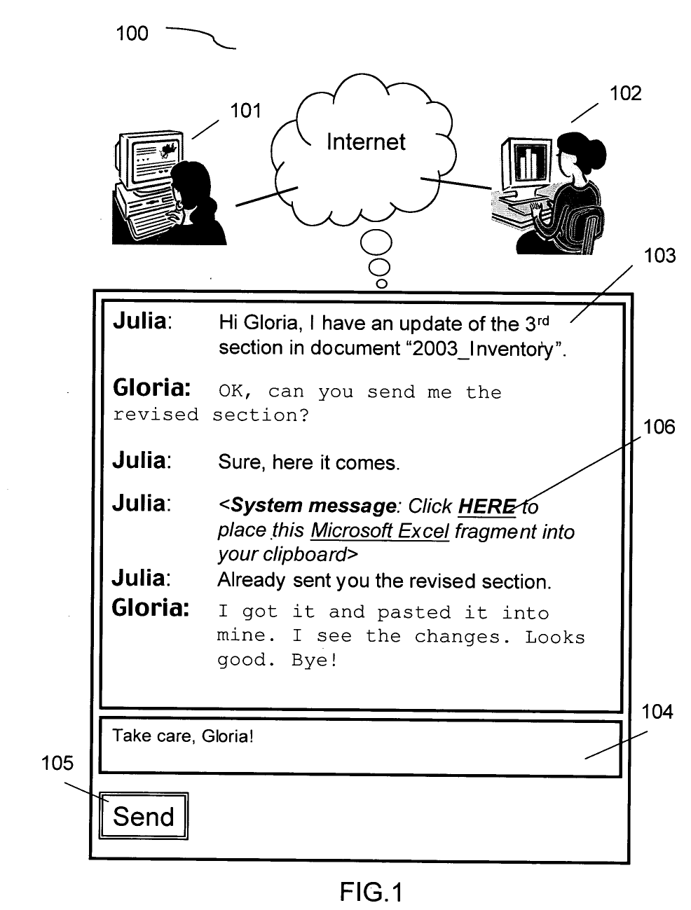

FIG. 1 is a schematic diagram illustrating an instant messaging system 100 which includes a graphic user interface and a number of computers which are communicatively connected via the Internet or a local area network (LAN). The users are working together to update a large spreadsheet such as an Excel document. They do not share a network connection that allows easy collaboration on the spreadsheet. But they can communicate via a messaging system and its associated client applications such as AOL's AIM. In this example, a sending user 101 sends a copy of a fragment of document to a receiving user 102 and the receiving user 102 then pastes the transferred data from her clipboard into her own document. In particular, the sending user 101 selects a section of several rows she has updated, copies them to her own clipboard, pastes the clipboard contents to the messaging system, sends to the receiving user 102 via the messaging system along with some text explaining the contents of the message. The receiving user 102 just makes a single click on an interface to have the receiving computer's clipboard being populated with the entire data from the sending computer's clipboard. The single click action is equivalent to the selection and copy functions made in a local document.

The graphic user interface for the instant messaging system 100 includes (1) a communication screen 103 where the participating users' messages are displayed, (2) a message entry box 104 where each user enters her message to be displayed in the communication screen 103, and (3) a virtual “Send” button 105 which invokes the display of the entered message to the communication screen 103. The content in the entry box 104 is visible to the user who is entering the message but is invisible to other participating users. The displayed messages in the communication screen 103, however, are visible to all participating users. When the sending user 101 pastes her clipboard content into the entry box 104 and then clicks the Send button 105, an automatically generated system message is posted in the communication screen 103.

The system message includes a link 106 which is notable, for example, as highlighted or underlined. When the receiving user 102 clicks the link 106, the receiving computer's clipboard is automatically populated with the transferred data which is a duplicate of the data imported from the sending computer's clipboard. Then, the receiving user 102 may paste the content in the receiving computer's clipboard into an appropriate place in her own spread sheet document just like a “copy” and “paste” from her own document. Similarly, the entire system message may be implemented as a link, which means when the receiving user 102 clicks anywhere of the system message, the receiving computer's clipboard is automatically populated.

The users can collaborate in this manner in both directions without the need to create and send updated copies of the whole spreadsheet file, and avoiding the versioning confusion that follows. The same concept to transfer a fragment of document is applicable to any application that supports “cut, copy and paste.”

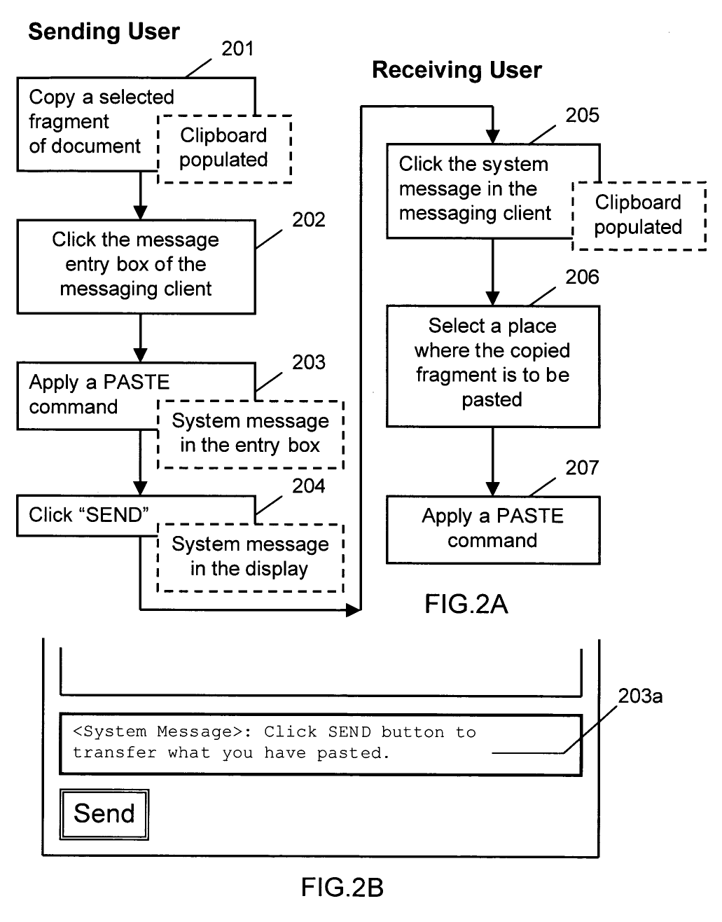

FIG. 2A is a flow diagram illustrating an exemplary process for transferring a fragment of document from a sending computer's clipboard to a receiving computer's clipboard via an instant messaging system. The process includes the following steps:

Step 201: The sending user copies a selected fragment of document, resulting in the sender's clipboard being populated;

Step 202: The sending user clicks the message entry box of the messaging system's client application;

Step 203: The sending user applies a standard Paste command (e.g. pressing “Ctrl” key and “V” key at the same time or clicking “Paste” from the “Edit” menu);

Step 204: The sending user clicks a Send button, resulting in such an automatically generated system message being immediately displayed in the communication screen as: <System message: Click HERE to place this Microsoft Excel fragment into your clipboard>.

Step 205: The receiving user clicks a link included in the system message, resulting in the receiver's clipboard being populated;

Step 206: The receiving user selects a place where the copied fragment is to be pasted; and

Step 207: The receiving user applies a standard Paste command, e.g. pressing “Ctrl” key and “V” key at the same time or clicking “Paste” from the “Edit” menu, resulting the copied fragment into the selected place by the receiving user.

In step 202, it is assumed that the messaging system is activated. Otherwise, the sending user may activate the messaging system any time.

In step 203, when the sending user applies the “Paste” command, the pasted data does not necessarily show in the entry box of the messaging system. Instead, the entry box may show an automatically generated system message immediately after the “Paste” command is given. FIG. 2B is a schematic diagram illustrating an exemplary system message in the entry box invoked by the sending user's “Paste” command. The entry box message 203a may take different forms depending on the specific implementation. For example, “<System Message>: your copied data has been transferred to the messaging system”, indicating that the entire data has been imported from the sending computer's clipboard into the messaging system's client application in the sending computer. For another example, “<System Message>: Click SEND button to transfer what you have pasted”, as illustrated in FIG. 2B, indicating that the sending computer's clipboard content will be transferred from the messaging system's client application in the sending computer to the messaging system's client application in the receiving computer immediately after a specific command, i.e. a single click on the “Send” button or a press on a keyboard key, is given by the sending user. Optionally, when the sending user applies the “Paste” command, the entry box shows the entire or partial of the copied fragment.

As for when the entire data are actually transferred from the sending computer's clipboard to the messaging system's client application in the sending computer, from the sending computer to the receiving computer via the messaging system's client applications, and from the messaging system's client application in the receiving computer to the receiving computer's clipboard, it defers depending on the implementation.

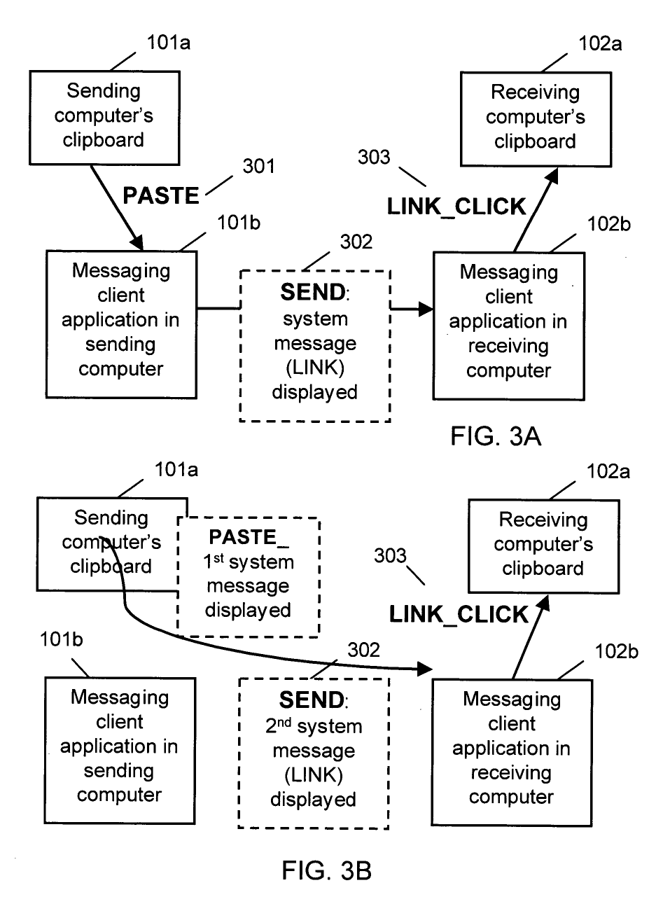

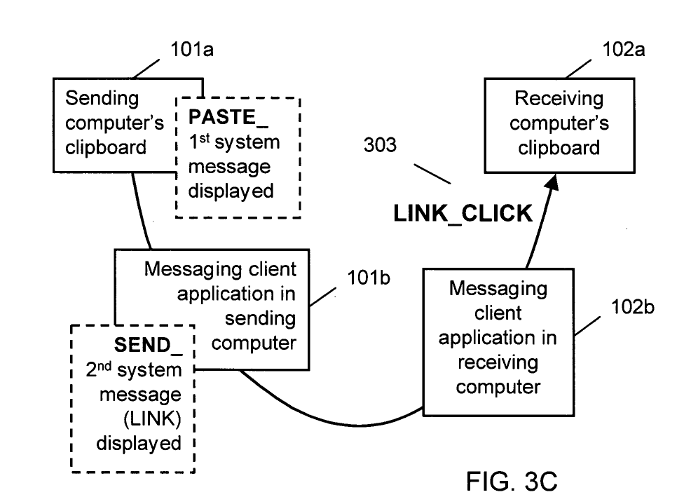

In one implementation as illustrated in FIG. 3A, the entire data in the sending computer's clipboard 101a is imported into the messaging system's client application in the sending computer 101b immediately after the sending user 101 applies a “Paste” command 301. When the sending user 101 clicks “Send” 302, the entire data is actually transferred from the sending computer to the receiving computer via the messaging system's client applications. At the same time, a system message, which includes a link, is displayed in the communication screen. When the receiving user 102 gives a “Link Click” command 303, i.e. clicks on the link included in the system message displayed in the messaging system's communication screen, the entire data is further transferred from the messaging system's client application in the receiving computer 102b to the receiving computer's clipboard 102a.

In another implementation as illustrated in FIG. 3B, immediately after the sending user 101 applies a “Paste” command, the messaging system display a first system message in the message entry box but the entire data in the sending computer's clipboard 101a is not transferred into the messaging system. When the sending user 101 clicks the “Send” 302, the entire data in the sending computer's clipboard 101a starts being transferred to the messaging system's client application in the sending computer 101b and then to the client application in the receiving computer 102b. At the same time, a second system message is displayed in the communication screen. When the receiving user 102 makes a “Link Click” 303, i.e. clicks on the link included in the second system message displayed in the messaging system's communication screen, the entire data is further transferred from the messaging system's client application in the receiving computer 102b to the receiving computer's clipboard 102a.

Yet in another implementation, as illustrated in FIG. 3c when the sending user 101 applies a “Paste” command, the messaging system display a first system message in the message entry box but the entire data in the sending computer's clipboard 101a is not transferred into the messaging system. When the sending user clicks the “Send” button, a second system message is displayed in the communication screen but no data transfer occurs. However, when the receiving user 102 makes a “Link Click” 303, i.e. clicks on the link included in the second system message displayed in the messaging system's communication screen, the entire data starts being transferred from the sending computer's clipboard 101a to the receiving computer's clipboard 102a via the messaging system's client applications.

Although the invention is described herein with reference to the preferred embodiment, one skilled in the art will readily appreciate that other applications may be substituted for those set forth herein without departing from the spirit and scope of the present invention.

Accordingly, the invention should only be limited by the claims included below.

1. An network based messaging system comprising:
means for importing entire data from a sending computer's clipboard in said messaging system; and
means for exporting said entire data from said sending computer to a receiving computer's clipboard;
wherein said sending computer and said receiving computer are communicatively connected via a network; and
wherein said entire data comprises document data and data for maintaining a formats of said document data.

2. The messaging system of claim 1, wherein said means for importing comprises:
means for displaying in a message entry box a first system message indicating that said entire data has been imported into said messaging system, said first system message being displayed in said entry box immediately after a standard paste command is applied.

3. The messaging system of claim 1, wherein said means for importing comprises:
means for displaying in a message entry box a first system message indicating that once a transfer command is given, said entire data is imported from said sending computer's clipboard into said messaging system, said first system message being displayed in said entry box immediately after a standard paste command is applied.

4. The messaging system of claim 3, wherein said transfer command is any of a single click on a virtual button and a press on a keyboard key.

5. The messaging system of claim 1, wherein said means for exporting comprises:
means for displaying in a communication screen a second system message, said second system message being displayed immediately after a transfer command is given by a sending user;
wherein when a receiving user clicks a link included in said system message, said entire data is exported to said receiving computer's clipboard.

6. A method for populating a remote computer's clipboard via a network based messaging system, said messaging system comprising a graphic user interface and a number of computers which are communicatively connected via said network, said interface comprising a message entry box where a user enters messages, a virtual button which invokes a send command, and a communication screen where messages sent by each user are displayed, said method comprising the steps of:
a sending user applying a standard paste command to transfer entire data of a sending computer's clipboard to said messaging system;
clicking said virtual button, which results in a system message being displayed in said communication screen, said system message comprising a link; and
a receiving user clicking said link, which results in said remote computer's clipboard being populated with said entire data.

7. A method for populating a remote computer's clipboard via a network based messaging system, said messaging system comprising a graphic user interface and a plurality of computers which are communicatively connected via network, said interface comprising a message entry box where a user enters messages, a virtual button which invokes a send command, and a communication screen where messages sent by each user are displayed, said method comprising the steps of:
a sending user copying a selected fragment of a document, which results in a sending computer's clipboard being populated;
clicking said entry box;
applying a standard paste command, which results in a transfer of entire data in said sending computer's clipboard into said messaging system;
clicking said virtual button, which results in said entire data being transferred to said remote computer and, at the same time, an automatically generated system message being displayed in said communication screen, said system message comprising a link; and
a receiving user clicking said link, which results in said remote computer's clipboard be populated with said entire data.

8. A method for populating a remote computer's clipboard via a network based messaging system, said messaging system comprising a graphic user interface and a plurality of computers which are communicatively connected via the network, said interface comprising a message entry box where a user enters messages, a virtual button which invokes a send command, and a communication screen where messages sent by each user are displayed, said method comprising the steps of:
a sending user copying a selected fragment of document, which results in a sending computer's clipboard being populated;
clicking said entry box;
applying a standard paste command, which results in a first system message being displayed in said entry box, said first system message indicating that entire data in said sending computer's clipboard has been transferred into said messaging system;
clicking said virtual button, which results in said entire data being transferred from said sending computer to said remote computer and, at the same time, a second system message being displayed in said communication screen, said second system message comprising a link; and
a receiving user clicking said link, which results in said remote computer's clipboard be populated with said entire data.

9. A method for populating a remote computer's clipboard via a network based messaging system, said messaging system comprising a graphic user interface and a number of computers which are communicatively connected via the network, said interface comprising a message entry box where a user enters messages, a virtual button which invokes a send command, and a communication screen where messages sent by each user are displayed, said method comprising the steps of:
a sending user copying a selected fragment of document, which results in a sending computer's clipboard being populated;
clicking said entry box;
applying a standard paste command, which results in a first system message being displayed in said entry box, said first system message indicating that if said virtual button is clicked, then entire data in said sending computer's clipboard is transferred into said messaging system;
clicking said virtual button, which results in a transfer of entire data from said sending computer's clipboard to said remote computer via said messaging system and, at the same time, a second system message being displayed in said communication screen, said second system message comprising a link; and
a receiving user clicking said link, which results in said remote computer's clipboard be populated with said entire data.

10. A method for populating a remote computer's clipboard via a network based messaging system, said messaging system comprising a graphic user interface and a number of computers which are communicatively connected via the network, said interface comprising a message entry box where a user enters messages, a virtual button which invokes a send command, and a communication screen where messages sent by each user are displayed, said method comprising the steps of:
a sending user copying a selected fragment of document, which results in a sending computer's clipboard being populated;
clicking said entry box;
applying a standard paste command, which results in a first system message being displayed in said entry box;
clicking said virtual button, which results in a second system being displayed in said communication screen, said second system message comprising a link; and
a receiving user clicking said link, which results in a transfer of entire data from said sending computer's clipboard to said remote computer's clipboard via said messaging system.
